(19) United States
(12) Patent Application Publication
(10) Pub. No.: US 2015/0039759 A1
(43) Pub. Date: Feb. 5, 2015

(54) APPARATUS, METHOD, AND NON-TRANSITORY COMPUTER READABLE STORAGE MEDIUM THEREOF FOR CONTROLLING ACCESS OF A RESOURCE

(71) Applicant: Institute For Information Industry, Taipei (TW)

(72) Inventors: Yen-Hung KUO, Taipei City (TW); Yu-Lin JENG, Tainan City (TW)

(73) Assignee: Institute For Information Industry, Taipei (TW)

(21) Appl. No.: 13/954,885

(22) Filed: Jul. 30, 2013

(51) Int. Cl. H04L 12/24

(52) U.S. Cl. CPC H04L 41/50
USPC 709/225

(57) ABSTRACT

Apparatus and method for controlling access of a resource and non-transitory computer readable storage medium thereof are provided. The apparatus includes a storage unit, an interface, and a processing unit, wherein the processing unit is electrically connected to the storage unit and the interface. The interface is configured to receive a request for generating a share link regarding the resource or a snapshotted version of the resource for a temporary account. The processing unit is configured to create the share link according to the temporary account and a permission setting of the temporary account and store the temporary account, the permission setting, and the share link in the storage unit. The share link and a permanent link of the resource are different. The interface is further configured to deliver the share link to the temporary account.

### FIELD

The present invention relates to an apparatus, a method, and a non-transitory computer readable storage medium thereof for controlling access of a resource. More particularly, the present invention relates to an apparatus, a method, and a non-transitory computer readable storage medium thereof for controlling access of a resource by creating different share links for different accounts according to different permission settings.

### BACKGROUND

Due to the well-developed network technology, various kinds of resources (e.g. files, folders, objects, websites, webpages, services, etc) are available through networks. People tend to distribute these resources by delivering share links via different communication mechanisms (e.g. e-mails, short message service, mobile phone applications, etc.).

Although sharing resources within an enterprise or among enterprises via share links is useful and convenient, the untraceability, uncontrollability, and high diffusibility of using share links become a critical information loophole/leak within an enterprise or among enterprises. To be more specific, a share link may be distributed without limitation, which causes the owner of a resource unable to know the exact person that has downloaded/used the resource. In addition, when sharing a resource via a share link, it is difficult in setting access rights to different users. For example, when a resource is a service having a plurality of functionalities, users that derive a share link to this service are able to access all its functionalities. Nevertheless, the owner of the service may want to prevent some users from using some of the functionalities. Moreover, some types of resources (e.g. announcements, contracts, and other documents) may evolve from time to time; however, it is difficult in sharing a snapshotted version (i.e. a certain version) of these kinds of resources by using conventional share links.

According to the above descriptions, a new type of share links that is able to share up-to-date and/or snapshotted resources with traceability and controllability while limiting diffusibility is in an urgent need.

### SUMMARY

To solve the above mentioned untraceability, uncontrollability, and high diffusibility of using conventional share links for sharing resources, the present invention provides an apparatus, a method, and a non-transitory computer readable storage medium thereof for controlling access of a resource. The resource is stored at a location pointed to by a permanent link, which may be a Universal Resource Identifier (URI), a Universal Resource Name (URN), a Universal Resource Locator (URL), or the like.

The aforementioned apparatus of certain embodiments of the present invention comprises a storage unit, an interface, and a processing unit, wherein the processing unit is electrically connected to the storage unit and the interface. The interface is configured to receive a request for generating a share link regarding the resource for an account. The processing unit is configured to create the share link according to the temporary account and a permission setting of the temporary account and store the temporary account, the permission setting, and the share link in the storage unit. It is emphasized that the share link and the permanent link of the resource are different. The interface is further configured to deliver the first share link to the first account.

The aforementioned method of certain embodiments of the present invention is executed by a computing apparatus and comprises the following steps of: (a) receiving a request for generating a share link regarding the resource for a temporary account, (b) creating the share link according to the temporary account and a permission setting of the temporary account, wherein the share link and the permanent link of the resource are different, (c) storing the temporary account, the permission setting, and the share link in a storage unit, and (d) delivering the share link to the temporary account.

The aforementioned non-transitory computer readable storage medium of certain embodiments of the present invention has a computer program stored therein. The computer program executes a method for controlling access of a resource after being loaded into a computing apparatus. The computer program comprises four modules. The first module is for receiving a request for generating a share link regarding the resource for a temporary account. The second module is for creating the share link according to the temporary account and a permission setting of the temporary account, wherein the share link and the permanent link of the resource are different. The third module is for storing the temporary account, the permission setting, and the share link in a storage unit. The fourth module is for delivering the share link to the temporary account.

According to the above descriptions, certain embodiments of the present invention create a share link according to a temporary account and a permission setting of the temporary account; hence, different temporary accounts will have different share links regarding to the same permanent link pointed to the same resource. In addition, the relation between the share link and the corresponding temporary account is stored for subsequent authentication. Consequently, when an access request of the resource is received via the share link, an access account, which is the account of communication mechanisms (e.g. an e-mail account, a cell phone number, or a social network service account) received the share link, has to be inputted for authentication as well. Only when the access account is equivalent to the temporary account corresponding to the share link, the resource then can be accessed. It is worth to mention that when the resource evolves from time to time, the present invention is capable for creating a snapshotted version of the resource in response to the request for generating the share link. Under such circumstance, the share link is linked to the snapshotted version of the resource. Based on the above mechanism, the problems of untraceability, uncontrollability, and high diffusibility of using share links can be avoided.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 illustrates an apparatus 1 for controlling access of a resource of the first embodiment; and

FIG. 2 illustrates a method for controlling access of a resource of the second embodiment.

### DETAILED DESCRIPTION

In the following descriptions, an apparatus, a method, and a non-transitory computer readable storage medium thereof for controlling access of a resource of the present invention will be explained with reference to embodiments thereof. However, these embodiments are not intended to limit the present invention to any environments, applications, or implementations described in these embodiments. Therefore, the description of these embodiments is only for the purpose of illustration rather than to limit the present invention. It shall be appreciated that in the following embodiments and attached drawings, elements not directly related to the present invention are omitted from depiction.

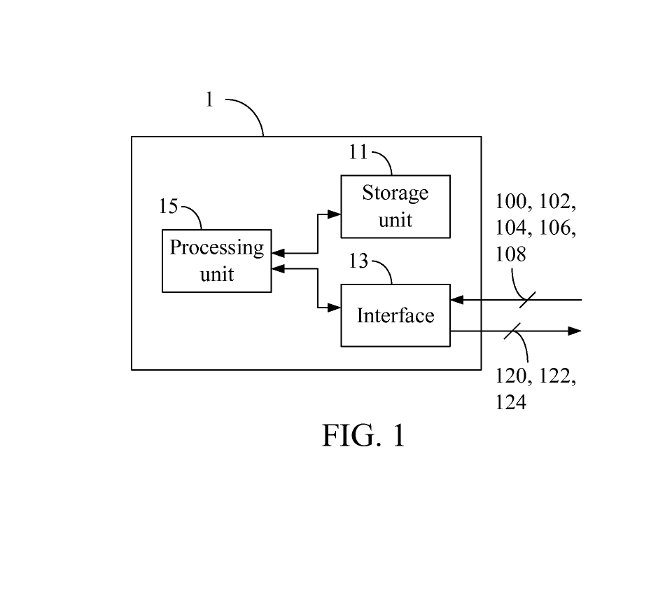

A first embodiment of the present invention is an apparatus 1 for controlling access of a resource and a schematic view of which is illustrated in FIG. 1. The apparatus 1 comprises a storage unit 11, an interface 13, and a processing unit 15, wherein the processing unit 15 is electrically connected to the storage unit 11 and the interface 13. The apparatus 1 may be a server or any electronic apparatus that has computing ability. The storage unit 11 may be a memory, a floppy disk, a hard disk, a compact disk (CD), a mobile disk, a magnetic tape, a database, or any other storage media with the same function and well-known to those of ordinary skill in the art or a circuit. The interface 13 may be any interface that can receive and transmit signals. The processing unit 15 may be any of various processors, central processing units (CPUs), microprocessors, or other computing devices well known to those of ordinary skill in the art.

In this embodiment, a resource may be a file, a folder, an object, a website, a webpage, a service, etc. Each resource is stored at a location pointed to by a permanent link, which may be a Universal Resource Identifier (URI), a Universal Resource Name (URN), a Universal Resource Locator (URL), or the like. For convenience, a first resource and a second resource will be detailed in this embodiment. It is noted that the number of resources that can be managed by the apparatus 1 in terms of access control is not limited in the present invention.

Access control of the first resource and the second resource may be managed by a user via the interface 13. Hereinafter, managing access control of the first resource for a first temporary account and a second temporary account is described. Each of the first temporary account and the second temporary account may be an e-mail address, a mobile phone number, an account of a social network (e.g. Facebook), etc. It is noted that the number of temporary accounts is not limited in the present invention as well.

The user may input a first request 100 for generating a first share link 120 regarding the first resource for the first temporary account and input a second request 102 for generating a second share link 122 regarding the first resource for the second temporary account. The interface 13 receives both the first request 100 and the second request 102. It is noted that the user may command the apparatus 1 to generate different share links of the first resource for different users in one single request in other embodiments.

Next, the processing unit 15 creates the first share link 120 of the first resource according to the first temporary account and a first permission setting (not shown) of the first temporary account. Depending on the type of the first resource, the first permission setting may be related to a password, a read control of the first resource, a write control of the first resource, an indication of the accessible portions/functionalities of the first resource, an expiration message, and/or other types of control. The first permission setting may be a default setting or may be carried in the first request 100. Following that, the processing unit 15 stores the first temporary account, the first permission setting, and the first share link 120 in the storage unit 11. For example, the processing unit 15 may store the first temporary account, the first permission setting, and the first share link 120 in a row of a mapping table in the storage unit 11.

Likewise, the processing unit 15 creates the second share link 122 of the first resource according to the second temporary account and a second permission setting of the second temporary account. Depending on the type of the first resource, the second permission setting may be related to a password, a read control of the first resource, a write control of the first resource, an indication of the accessible portions/functionalities of the first resource, an expiration message, and/or other types of control as well. The second permission setting may be the default setting or may be carried in the request 102. Following that, the processing unit 15 stores the second temporary account, the second permission setting, and the second share link 122 in the storage unit 11. For example, the processing unit 15 may store the second account, the second permission setting, and the second share link 122 in another row of the mapping table in the storage unit 11.

It is emphasized that the first share link 120, the second share link 122, and the permanent link of the first resource are all different. Even the first permission setting and the second permission setting are the same, the first share link 120 and the second share link 122 are still different and delivered to the first and second temporary accounts respectively.

After the creation of the first share link 120, the interface 13 directly delivers the first share link 120 to the first temporary account. The communication mechanism for delivering the first share link 120 to the first temporary account depends on the type of the first temporary account. For example, when the first temporary account is an e-mail account, the first share link 120 is delivered to the first temporary account via an e-mail. Yet as another example, when the first temporary account is a cell phone number, the first share link 120 is delivered to the first temporary account via a short message. Similarly, after the creation of the second share link 122, the interface 13 directly delivers the second share link 122 to the second temporary account. The communication mechanism for delivering the second share link 122 to the second temporary account depends on the type of the second temporary account as well. To prevent from being either arbitrarily distributed or abuse, the first share link 120 and the second share link 122 will not be displayed and cannot be copied at the apparatus 1.

At a later stage, the interface 13 receives an access request 104 via the first share link 100 from a client. To perform authentication, the interface 13 further receives an access account 106 from the client. The processing unit 15 has the knowledge that the first share link 120 corresponds to the first temporary account according to the information stored in the storage unit 11. Then, the processing unit 15 determines whether the access account 106 is equivalent to the first temporary account. Only when the access account 106 is equivalent to the first temporary account will the processing unit 15 further provides the first resource to the client according to the first permission setting. For example, when the first permission is the client can read the first resource only, the processing unit 15 will provide the first resource in this way to the client.

In other embodiments, the first permission setting is related to an expiration message, such as a date that the first share link 100 will expire. For these embodiments, the processing unit 15 will delete the first temporary account, the first permission setting, and the first share link 120 from the storage unit 11 when the first share link 100 expires. Under such circumstance, when the interface 13 receives the access request 104 via the first share link 100, the interface 13 further delivers an error message to the client because the processing unit 15 finds no information of the first share link 100 (i.e. the processing unit 15 determines that the first share link 120 expires) in the storage unit 11. In this case, once the first share link 100 expires, any client cannot access the resource via the first share link 100.

In other embodiments, after the processing unit 15 determines that the access account 106 is equivalent to the first account, the processing unit 15 further retrieves all other share links from the storage unit 11 according to the first temporary account. In other words, all share links that has been created for the first temporary account will be retrieved and may be displayed and/or delivered to the first account again. In this way, all share links for the first account can be managed easily.

In yet another embodiment, the storage unit 11 is further stored with a profile (not shown) of a user who owns the first temporary account. The profile comprises the first temporary account and other temporary account(s) of the user. For these embodiments, after the processing unit 15 determines that the access account 106 is equivalent to the first temporary account, the processing unit 15 further retrieves all other share links from the storage unit 11 according to every temporary account comprised in the profile. That is, all share links that has been created for the user will be retrieved and may be displayed and/or delivered to the user again. In this way, all share links for the user account can be managed easily.

Based on the above descriptions, people ordinary skilled in the art can understand that the apparatus 1 will perform similar processes for authentication, access control, and share link management when the interface 13 receives another access request via the second share link 122 from another client.

Next, managing access control of the second resource (i.e. a resource that evolves from time to time) for a first temporary account is described. In this case, upon receiving a third request 108 for generating a third share link 124 regarding the second resource for the first temporary account, the processing unit 15 creates a snapshotted version (not shown) of the second resource in response to the third request 108 and then creates the third share link 124 according to the first temporary account and another permission setting of the first temporary account. In addition, the procession unit 15 stores the first temporary account, the another permission setting, the third share link 124, and a snapshotted version of the second resource in the storage unit 11. It is noted that the third share link 124 is linked to the snapshotted version of the second resource and the third share link 124 is different from the permanent link of the second resource.

Similarly, when the interface 13 receives another access request via the third share link 124 from another client, the apparatus 1 will perform similar processes for authentication, access control, and share link management as addressed above. When the authentication process has been passed, the snapshotted version of the second resource instead of the latest version of the second resource is presented/shown/delivered.

According to the above descriptions, it is understand that the apparatus 1 creates a share link of a resource for a temporary account according to the temporary account and its permission setting. Hence, a resource with access control can be provided to the user who owns the temporary account. In addition, the share links of a resource for different temporary accounts are different (no matter whether their permission settings are the same or different) and the relationship between a share link, an temporary account, and a permission setting is stored in the storage unit 11; hence, the share link is traceable. That is, anyone who access the resource via a share link, it can be determined that the share link is distributed by the owner of the corresponding temporary account. By using the apparatus 1 for creating share links of resources, the problems of untraceability, uncontrollability, and high diffusibility of using share links can be avoided.

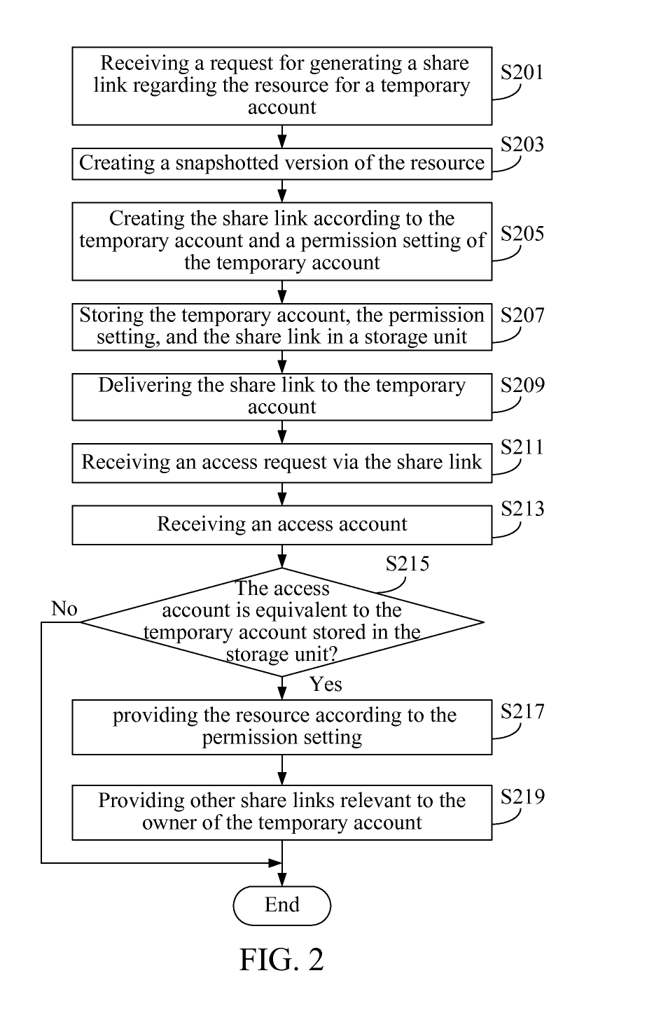

A second embodiment of the present invention is a method for controlling access of a resource and a flowchart of which is illustrated in FIG. 2. The method is adapted to be executed by a computing apparatus, such as the apparatus 1 in the first embodiment.

Firstly, step S201 is executed for receiving a request for generating a share link regarding a snapshotted version of the resource for a temporary account. Next, step S203 is executed for creating a snapshotted version of the resource in response to step S201. In other embodiments, when the request received in step S201 is a request for generating a share link toward the latest version of the resource, step S203 can be omitted.

Following that, step S205 is executed for creating the share link according to the temporary account and a permission setting of the temporary account. It is noted that the share link and a permanent link of the resource are different. In addition, when the step S203 has been executed, the share link is generated with reference to the snapshotted version of the resource. Next, step S207 is executed for storing the temporary account, the permission setting, and the share link in a storage unit. Step S209 is then executed for delivering the share link to the temporary account. If there is another account requires a share link of the resource, the method repeats steps S201 to S209.

Later on, step S211 is further executed for receiving an access request via the share link generated in step S205. To perform authentication, step S213 is further executed for receiving an access account. Following that, step S215 is executed for determining whether the access account is equivalent to the temporary account stored in the storage unit (i.e. whether the access account is equivalent to the account corresponding to the share link).

If the access account is not equivalent to the account stored in the storage unit, the method terminates the procedure. If the access account is equivalent to the account stored in the storage unit, step S217 is further executed for providing the resource according to the permission setting. Following that, step S219 is executed for providing other shared links relevant to the owner of the account. In some embodiments, step S219 is realized by retrieving other shared link from the storage unit according to the account. That is, all shared links that have been created for the account will be retrieved.

In some other embodiments, the storage unit is stored with a profile (not shown) of a user who owns the temporary account. The profile comprises the temporary account and other temporary account(s) of the user. For these embodiments, step S219 is realized by all other share links from the storage unit according to every temporary account comprised in the profile. That is, all share links that has been created for the user will be retrieved. After the execution of step S219, the method terminates the procedure.

In other embodiments, the method may execute another step (not shown) for determining whether any share link expires from time to time. If any share link expires, the method executes another step (not shown) for deleting the temporary account, the permission setting, and the share link from a storage unit. For these embodiments, after the step S211, the method executes another step (not shown) for determining whether the storage unit has information of the share link carried in the access request. If no information of the share link can be found in the storage unit, the method executes another step (not shown) for delivering an error message. If the storage unit has information of the share link, the method then continues to execute step S213.

In addition to the aforesaid steps, the second embodiment can also execute all the operations and function set forth in the first embodiment. How the second embodiment executes these operations and functions will be readily appreciated by those of ordinary skill in the art based on the explanation of the first embodiments, and thus will not be further described herein.

The method for controlling access of a resource described in the second embodiment may be implemented by a computer program having a plurality of codes. The computer program is stored in a non-transitory computer readable storage medium. When the codes are loaded into a computing apparatus (e.g. the apparatus 1 in the first embodiment), the computer program executes the method as described in the second embodiment. The non-transitory computer readable storage medium may be an electronic product, such as a read only memory (ROM), a flash memory, a floppy disk, a hard disk, a compact disk (CD), a mobile disk, a magnetic tape, a database accessible to networks, or any other storage media with the same function and well known to those skilled in the art.

According to the above descriptions, the present invention creates a share link according to a temporary account and a permission setting of the temporary account; hence, different temporary accounts will have different share links regarding to the same resource. In addition, the relation between the share link and the corresponding temporary account is stored for subsequent authentication. Consequently, when an access request of the resource is received via the share link, an access account has to be inputted for authentication as well. Only when the access account is equivalent to the temporary account corresponding to the share link, the resource can then be accessed. It is worth to mention that when the resource evolves from time to time, the present invention is capable for creating a snapshotted version of the resource in response to the request for generating the share link. Under such circumstance, the share link is linked to the snapshotted version of the resource. Based on the above mechanism, the problems of untraceability, uncontrollability, and high diffusibility of using share links can be avoided.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. An apparatus for controlling access of a resource, comprising:
a storage unit;
an interface, being configured to receive a first request for generating a first share link regarding the resource for a first temporary account;
a processing unit, being electrically connected to the storage unit and the interface and configured to create the first share link according to the first temporary account and a first permission setting of the first temporary account and store the first temporary account, the first permission, and the first share link in the storage unit, wherein the first share link and a permanent link of the resource are different;
wherein the interface is further configured to deliver the first share link to the first temporary account.

2. The apparatus of claim 1, wherein the processing unit is further configured to create a snapshotted version of the resource in response to the first request and the first share link is linked to the snapshotted version of the resource.

3. The apparatus of claim 1, wherein the interface is further configured to receive an access request via the first share link, the interface is further configured to receive an access account, the processing unit is further configured to determine that the access account is equivalent to the first temporary account stored in the storage unit, and the processing unit is further configured to provide the resource according to the first permission setting.

4. The apparatus of claim 3, wherein the processing unit is further configured to retrieve a second share link from the storage unit according to the first temporary account.

5. The apparatus of claim 3, wherein the storage unit is further stored with a profile of a user, the profile comprises the first temporary account and a second temporary account, and the processing unit further retrieves a second share link from the storage unit according to the second temporary account.

6. The apparatus of claim 1, wherein the processing unit is further configured to determine that the first share link expires and delete the first temporary account, the first permission, and the first share link from the storage unit after determining that the first share link expires.

7. The apparatus of claim 6, wherein the interface is further configured to receive an access request via the first share link, the processing unit is further configured to determine no information of the first share link in the storage unit, and the interface is further configured to deliver an error message.

8. The apparatus of claim 1, wherein the interface is further configured to receive a second request for generating a second share link regarding the resource for a second temporary account, the processing unit is further configured to create the second share link according to the second temporary account and a second permission setting of the second temporary account, store the second temporary account, the second permission setting, and the second share link in the storage unit, and the interface is further configured to deliver the second share link to the second temporary account, wherein the first share link, the second share link, and the permanent link of the resource are different.

9. The apparatus of claim 1, wherein the first permission setting is related to one of a password, a read control of the resource, a write control of the resource, an expiration message, and the combination thereof.

10. A method for controlling access of a resource, the method being executed by a computing apparatus and comprising the steps:
receiving a first request for generating a first share link regarding the resource for a first temporary account;
creating the first share link according to the first temporary account and a first permission setting of the first temporary account, wherein the first share link and a permanent link of the resource are different;
storing the first temporary account, the first permission setting, and the first share link in a storage unit; and
delivering the first share link to the first account.

11. The method of claim 10, further comprising the step of:
creating a snapshotted version of the resource in response to the first request and the first share link is linked to the snapshotted version of the resource.

12. The method of claim 10, further comprising the steps of:
receiving an access request via the first share link;
receiving an access account;
determining that the access account is equivalent to the first temporary account stored in the storage unit; and
providing the resource according to the first permission setting.

13. The method of claim 12, further comprising the step of:
retrieving a second share link from the storage unit according to the first temporary account.

14. The method of claim 12, wherein the storage unit is further stored with a profile of a user, the profile comprises the first temporary account and a second temporary account, and the method further comprises the step of:
retrieving a second share link from the storage unit according to the second temporary account.

15. The method of claim 10, further comprising the steps of:
determining that the first share link expires; and
deleting the first temporary account, the first permission, and the first share link from the storage unit after determining that the first share link expires.

16. The method of claim 10, further comprising the steps of:
receiving an access request via the first share link;
determining no information of the first share link in the storage unit; and
delivering an error message.

17. The method of claim 10, further comprising the steps of:
receiving a second request for generating a second share link regarding the resource for a second temporary account;
creating the second share link according to the second temporary account and a second permission setting of the second temporary account, wherein the first share link, the second share link, and the permanent link of the resource are different;
storing the second temporary account, the second permission setting, and the second share link in the storage unit; and
delivering the second share link to the second temporary account.

18. The method of claim 10, wherein the first permission setting is related to one of a password, a read control of the resource, a write control of the resource, an expiration message, and the combination thereof.

19. A non-transitory computer readable storage medium, having a computer program stored therein, the computer program executing a method for controlling access of a resource after being loaded into a computing apparatus, and the computer program comprising:
a first module for receiving a request for generating a share link regarding the resource for an account;
a second module for creating the share link according to the temporary account and a permission setting of the temporary account, wherein the share link and a permanent link of the resource are different;
a third module for storing the temporary account and the share link in a storage unit; and
a fourth module for delivering the share link to the temporary account.
